(19) United States
(12) Patent Application Publication
(10) Pub. No.: US 2020/0400200 A1
(43) Pub. Date: Dec. 24, 2020

(54) CLUTCH DEVICE FOR A TRANSMISSION

(71) Applicant: Schaeffler Technologies AG & Co. KG, Herzogenaurach (DE)

(72) Inventor: Michael Hodge, Creston, OH (US)

(73) Assignee: Schaeffler Technologies AG & Co. KG, Herzogenaurach (DE)

(21) Appl. No.: 16/902,442

(22) Filed: Jun. 16, 2020

Related U.S. Application Data
(60) Provisional application No. 62/864,393, filed on Jun. 20, 2019.

(51) Int. Cl. F16D 13/64; F16D 13/52; F16D 48/06

(52) U.S. Cl. CPC F16D 13/64; F16D 13/52; F16D 2500/30412; F16D 2500/1066; F16D 48/06

(57) ABSTRACT

A clutch assembly comprises a first clutch member configured to selectively couple a first torque input and a second torque input for torque transmission therebetween. The clutch assembly includes a second clutch member configured to selectively couple the second torque input and a third torque input for torque transmission therebetween. In one embodiment, the first clutch member is nested radially inside the first torque input, the second torque input is nested radially inside the first clutch member, the second clutch member is nested radially within the second torque input, and the third torque input is nested radially within the second clutch member.

### CROSS-REFERENCE TO RELATED APPLICATIONS

This application claims the benefit of U.S. Provisional Patent Application No. 62/864,393, filed Jun. 20, 2019, the disclosure of which is incorporated in its entirety by reference herein.

### TECHNICAL FIELD

The present disclosure relates to clutch devices for transmission applications and more particularly for a hybrid transmission.

### BACKGROUND

A clutch is a component used to selectively couple two or more components such as rotatable shafts. The clutch may be engaged to couple the components and may be disengaged to decouple the components.

### SUMMARY

Embodiments of the present disclosure provide a clutch assembly comprising a first clutch member configured to selectively couple a first torque input and a second torque input for torque transmission therebetween. The clutch assembly further includes a second clutch member configured to selectively couple the second torque input and a third torque input for torque transmission therebetween. In one embodiment, the first clutch member is nested radially inside the first torque input, the second torque input is nested radially inside the first clutch member, the second clutch member is nested radially within the second torque input, and the third torque input is nested radially within the second clutch member.

In a first mode of operation, the first clutch member decouples the first torque input from the second torque input; and the second clutch member decouples the second torque input from the third torque input. In a second mode of operation, the first clutch member couples the first torque input with the second torque input; and the second clutch member decouples the second torque input from the third torque input. In a third mode of operation, the first clutch member decouples the first torque input from the second torque input; and the second clutch member couples the second torque input with the third torque input. In a fourth mode of operation, the first clutch member couples the first torque input to the second torque input; and the second clutch member couples the second torque input with the third torque input.

In embodiments, the first torque input includes spline features formed on an inner diameter and the second torque input includes spline features formed on inner and outer diameters.

The first clutch member may include spline features formed on inner and outer diameters, wherein: the spline features on the outer diameter of the first clutch member are arranged to matingly engage with the spline features on the inner diameter of the first torque input; and the spline features on the inner diameter of the first clutch member are configured to matingly engage with the spline features on the outer diameter of the second torque input. In other embodiments, the third torque input includes spline features formed on an outer diameter and the second clutch member includes spline features formed on inner and outer diameters. The spline features formed on the outer diameter of the second clutch member may be configured to matingly engage with the spline features on the inner diameter of the second torque input and the spline features formed on the inner diameter of the second clutch member may be configured to matingly engage with the spline features formed on the outer diameter of the third torque input.

In embodiments, a clutch assembly comprises a first clutch member movable between an engaged position and a disengaged position to selectively couple a first torque input and a second torque input for torque transmission therebetween. The clutch assembly may further comprise a second clutch member movable between an engaged position and a disengaged position to selectively couple the second torque input and a third torque input for torque transmission therebetween. In a first mode of operation, the first clutch member and the second clutch member are both in the disengaged position such that the first torque input is decoupled from the second torque input and the second torque input is decoupled from the third torque input. In a second mode of operation, the first clutch member is in the engaged position such that the first torque input is coupled to the second torque input and the second clutch member is in the disengaged position such that the second torque input is decoupled from the third torque input. In a third mode of operation, the first clutch member is in the disengaged position such that the first torque input is decoupled from the second torque input and the second clutch member is in the engaged position such that the second torque input is coupled to the third torque input. In a fourth mode of operation, the first clutch member and the second clutch member are both in the engaged position such that the first torque input is coupled to the second torque input and the second torque input is coupled to the third torque input.

In embodiments, the first torque input includes surface features formed on an inner diameter and the second torque input includes surface features formed on an outer diameter. The first clutch member may include surface features formed on inner and outer diameters thereof, wherein, in response to the first clutch member being in the engaged position: the surface features on the outer diameter of the first clutch member matingly engage with the surface features on the inner diameter of the first torque input; and the surface features on the inner diameter of the first clutch member matingly engage with the surface features on the outer diameter of the second torque input. The surface features formed on the first torque input, the second torque input, and the first clutch member may be in the form of splines. In embodiments, the second torque input includes surface features formed on an inner diameter and the third torque input includes surface features formed on an outer diameter. The second clutch member includes surface features formed on inner and outer diameters thereof, wherein, in response to the second clutch member being in the engaged position: the surface features formed on the outer diameter of the second clutch member matingly engage with the surface features on the inner diameter of the second torque input; and the surface features formed on the inner diameter of the second clutch member matingly engage with the surface features formed on the outer diameter of the third torque input. The surface features formed on the second torque input, the third torque input, and the second clutch member may be in the form of splines.

In embodiments, the first clutch member is disposed radially within the first torque input; the second torque input is disposed radially within the first clutch member; the second clutch member is disposed radially within the second torque input; and the third torque input is disposed radially within the second clutch member.

In embodiments, a method of operating a clutch assembly having a first clutch member and a second clutch member is provided. The method includes moving the first clutch member between a first position where a first torque input is coupled to a second torque input to transmit torque therebetween and a second position where the first torque input is decoupled from the second torque input such that there is no torque transmission therebetween. The method further includes moving the second clutch member between a first position where the second torque input is coupled to a third torque input to transmit torque therebetween and a second position where the second torque input is decoupled from the third torque input such that there is no torque transmission therebetween. The first clutch member is disposed radially between the first torque input and the second torque input, and the second clutch member is disposed radially inward of the first clutch member and radially between the second torque input and the third torque input.

In a first mode of operation, the method includes: moving the first clutch member to the second position wherein the first torque input is decoupled from the second torque input; and moving the second clutch member to the second position wherein the second torque input is decoupled from the third torque input. In a second mode of operation, the method includes: moving the first clutch member to the first position wherein the first torque input is coupled to the second torque input; and moving the second clutch member to the second position wherein the second torque input is decoupled from the third torque input. In a third mode of operation, the method includes: moving the first clutch member to the second position wherein the first torque input is decoupled from the second torque input; and moving the second clutch member to the first position wherein the second torque input is coupled to the third torque input. In a fourth mode of operation, the method includes: moving the first clutch member to the first position wherein the first torque input is coupled to the second torque input; and moving the second clutch member to the first position wherein the second torque input is coupled to the third torque input.

### BRIEF DESCRIPTION OF THE DRAWINGS

FIG. 1 shows a cross-sectional view of a clutch assembly having first and second clutch members according to embodiments of the present disclosure.

FIG. 2 is a partial side cross-sectional view of the clutch assembly of FIG. 1 in a first mode of operation where both clutch members are in a disengaged position.

FIG. 3 is a partial side cross-sectional view of the clutch assembly of FIG. 1 in a second mode of operation with the first clutch member in an engaged position and the second clutch member in a disengaged position.

FIG. 4 is a partial side cross-sectional view of the clutch assembly of FIG. 1 in a third mode of operation with the first clutch member in a disengaged position and the second clutch member in an engaged position.

FIG. 5 is a partial side cross-sectional view of the clutch assembly of FIG. 1 in a fourth mode of operation with both clutch members in an engaged position.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

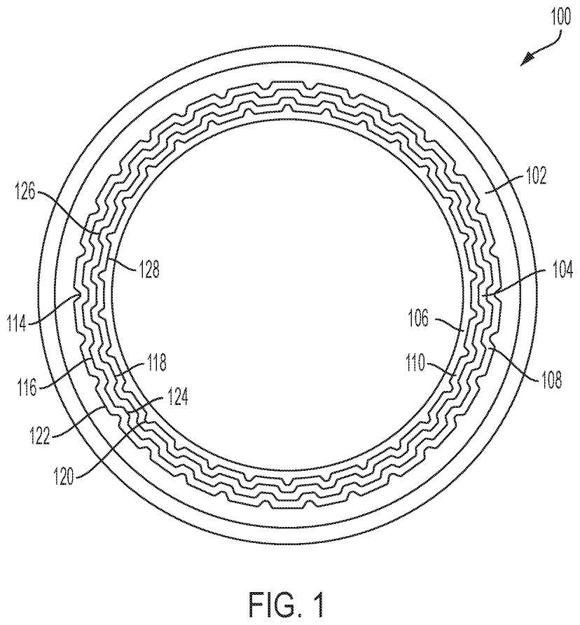

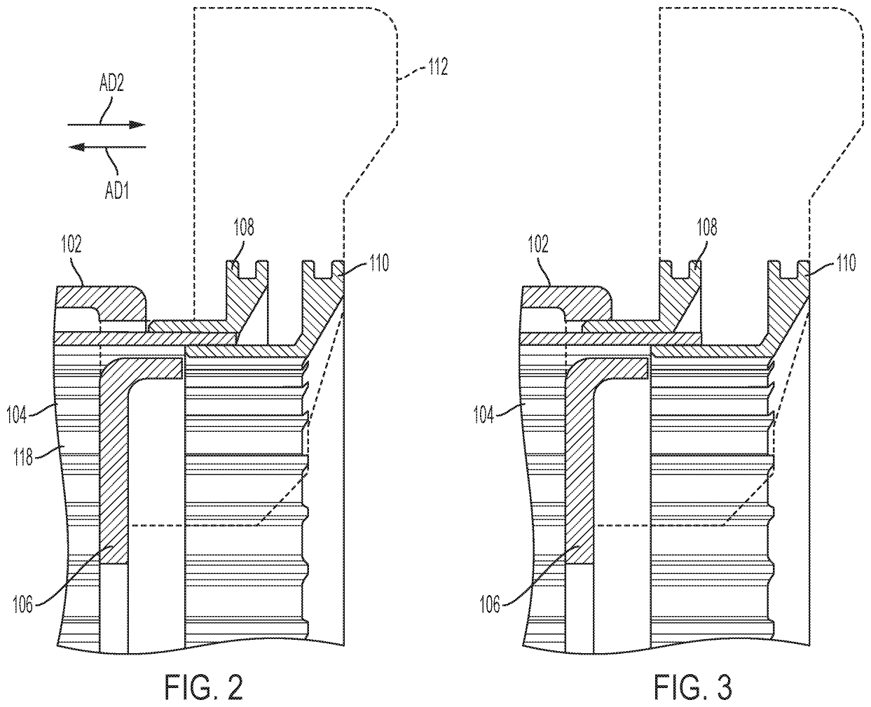

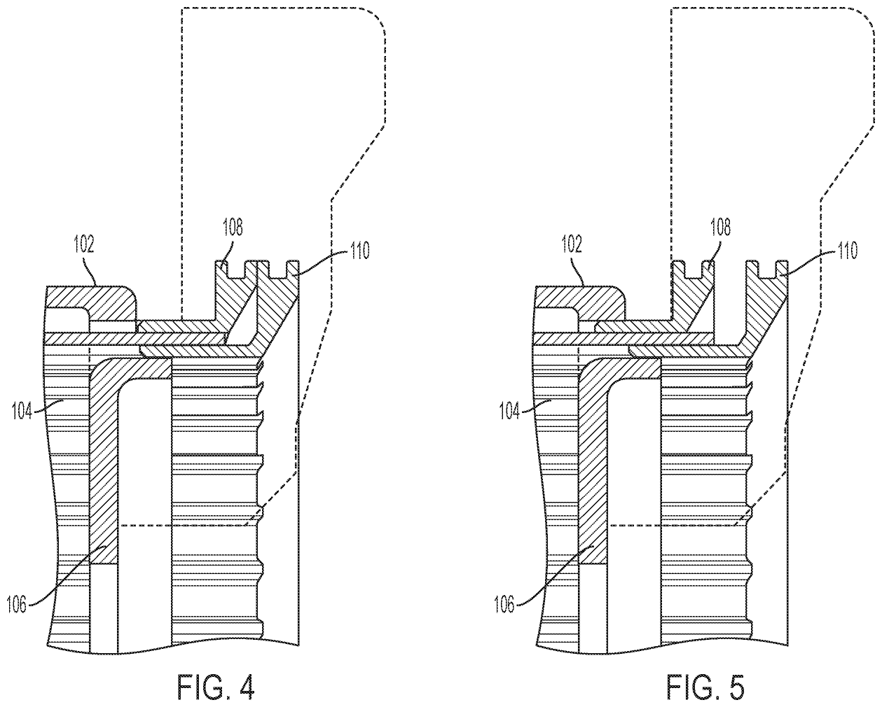

FIG. 1 shows a clutch assembly 100 having a first clutch member 108 and a second clutch member 110 according to embodiments of the present disclosure. FIG. 2 shows clutch assembly 100 in a first mode of operation where both the first and second clutch members 108, 110 are in a disengaged position. FIG. 3 shows clutch assembly 100 in a second mode of operation with the first clutch member 108 in an engaged position and the second clutch member 110 in a disengaged position. FIG. 4 shows clutch assembly 100 in a third mode of operation with first clutch member 108 in a disengaged position and second clutch member 110 in an engaged position. FIG. 5 shows clutch assembly 100 in a fourth mode of operation with both clutch members 108, 110 in an engaged position. The following description is made with reference to FIGS. 1-5.

Clutch assembly 100 includes: first torque input 102, second torque input 104, third torque input 106, first clutch member 108, second clutch member 110, and actuator 112. First clutch member 108, which may also be referred to as a high clutch, is arranged and configured to selectively couple first torque input 102 with second torque input 104. That is, first clutch member 108 may be actuated, or displaced in a first axial direction AD1, to an engaged position where first torque input 102 is coupled with second torque input 104 for torque transmission therebetween. Likewise, first clutch member 108 may be actuated, or displaced in a second axial direction AD2 opposite first axial direction AD1, to a disengaged position where first torque input 102 is decoupled from second torque input 104 such that torque is not transmitted therebetween.

First clutch member 108 includes surface features 122, such as splines, formed on an outer diameter thereof that are configured to matingly engage with surface features 114 of first torque input 102 when first clutch member 108 is in the engaged position (see, for example, FIG. 3). Surface features 114 may be splines, for example, and are formed on an inner diameter of first torque input 102 to facilitate engagement with first clutch member 108. First clutch member 108 further includes surface features 124, such as splines, formed on an inner diameter thereof that are configured to matingly engage with surface features 116 of second torque input 104 when first clutch member 108 is in the engaged position (see, for example, FIG. 3). Surface features 116 may be splines, for example, and are formed on an outer diameter of second torque input 104 to facilitate engagement with first clutch member 108.

Second clutch member 110, which may be referred to as a low clutch, is configured to selectively couple second torque input 104 with third torque input 106. That is, second clutch member 110 may be actuated, or displaced in first axial direction AD1, to an engaged position where second torque input 104 is coupled with third torque input 106 for torque transmission therebetween. Likewise, second clutch member 110 may be actuated, or displaced in second axial direction AD2 opposite first axial direction AD1, to a disengaged position where second torque input 104 is decoupled from third torque input 106 such that torque is not transmitted therebetween.

Second clutch member 110 includes surface features 126, such as spline teeth, formed on an outer diameter thereof that are configured to matingly engage with surface features 118 of second torque input 104 when second clutch member 110 is in the engaged position (see, for example, FIG. 5). Surface features 118 may be in the form of splines, for example, and are formed on an inner diameter of second torque input 104 to facilitate engagement with second clutch member 110. Second clutch member 110 further includes surface features 128, such as splines, formed on an inner diameter thereof configured to matingly with surface features 120 of third torque input 106 when second clutch member 110 is in the engaged position (see, for example, FIG. 5). Surface features 120 may be in the form of splines, for example, and are formed on an outer diameter of third torque input 106 to facilitate engagement with second clutch member 110. First torque input 102, second torque input 104, third torque input 106 may be supplied from a power source combination of an engine and/or e-machine, for example.

First and second clutch members 108, 110 may be actuated by actuator 112 to be displaced in first axial direction AD1 and second axial direction AD2 opposite first axial direction AD1. The actuator may be hydraulic or pneumatic, for example. Clutch assembly 100 may be operated in four modes as described in more detail below.

In a first mode of operation shown in FIG. 2, first clutch member 108 and second clutch member 110 are both in a disengaged position. That is, first torque input 102 and second torque input 104 are decoupled from each other such that torque is not transmitted therebetween. Likewise, second torque input 104 is decoupled from third torque input 106 such that torque is not transmitted therebetween.

In a second mode of operation shown in FIG. 3, first clutch member 108 is in an engaged position and second clutch member 110 is in a disengaged position. That is, first torque input 102 is coupled to second torque input 104 such that torque is transmitted therebetween. And, second torque input 104 is decoupled from third torque input 106 such that no torque is transmitted therebetween.

In a third mode of operation shown in FIG. 4, first clutch member 108 is in a disengaged position and second clutch member 110 is in an engaged position. That is, first torque input 102 is decoupled from second torque input 104 such that no torque is transmitted therebetween. And, second torque input 104 is coupled to third torque input 106 such that torque is transmitted therebetween.

In a fourth mode of operation shown in FIG. 5, first clutch member 108 is in an engaged position and second clutch member 110 is in an engaged position. That is, first torque input 102 is coupled to second torque input 104 such that torque is transmitted therebetween. And, second torque input 104 is coupled to third torque input 106 such that torque is transmitted therebetween.

As can be seen in the figures, first torque input 102, second torque input 104, third torque input 106, first clutch member 108, and second clutch member 110 are arranged to have a nested spline geometry that allows placement in smaller package spaces. Moreover, by nesting the spline geometry of the various input/output members as well as the clutching members, a torque dense system, meeting high load requirements can fit into a much smaller package space than other clutch devices.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A clutch assembly comprising:
a first clutch member configured to selectively couple a first torque input and a second torque input for torque transmission therebetween;
a second clutch member configured to selectively couple the second torque input and a third torque input for torque transmission therebetween; and
wherein the first clutch member is nested radially inside the first torque input, the second torque input is nested radially inside the first clutch member, the second clutch member is nested radially within the second torque input, and the third torque input is nested radially within the second clutch member.

2. The clutch assembly of claim 1, wherein, in a first mode of operation:
the first clutch member decouples the first torque input from the second torque input; and
the second clutch member decouples the second torque input from the third torque input.

3. The clutch assembly of claim 2, wherein, in a second mode of operation:
the first clutch member couples the first torque input with the second torque input; and
the second clutch member decouples the second torque input from the third torque input.

4. The clutch assembly of claim 3, wherein, in a third mode of operation:
the first clutch member decouples the first torque input from the second torque input; and
the second clutch member couples the second torque input with the third torque input.

5. The clutch assembly of claim 4, wherein, in a fourth mode of operation:
the first clutch member couples the first torque input to the second torque input; and
the second clutch member couples the second torque input with the third torque input.

6. The clutch assembly of claim 1, wherein:
the first torque input includes spline features formed on an inner diameter;
the second torque input includes spline features formed on inner and outer diameters; and
the first clutch member includes spline features formed on inner and outer diameters, wherein:
the spline features on the outer diameter of the first clutch member are configured to matingly engage with the spline features on the inner diameter of the first torque input; and
the spline features on the inner diameter of the first clutch member are configured to matingly engage with the spline features on the outer diameter of the second torque input.

7. The clutch assembly of claim 6, wherein:
the third torque input includes spline features formed on an outer diameter; and
the second clutch member includes spline features formed on inner and outer diameters, wherein:
the spline features formed on the outer diameter of the second clutch member are configured to matingly engage with the spline features on the inner diameter of the second torque input; and
the spline features formed on the inner diameter of the second clutch member are configured to matingly engage with the spline features formed on the outer diameter of the third torque input.

8. A clutch assembly comprising:
a first clutch member movable between an engaged position and a disengaged position to selectively couple a first torque input and a second torque input for torque transmission therebetween; and
a second clutch member movable between an engaged position and a disengaged position to selectively couple the second torque input and a third torque input for torque transmission therebetween,
wherein:
in a first mode of operation, the first clutch member and the second clutch member are both in the disengaged position such that the first torque input is decoupled from the second torque input and the second torque input is decoupled from the third torque input;
in a second mode of operation, the first clutch member is in the engaged position such that the first torque input is coupled to the second torque input and the second clutch member is in the disengaged position such that the second torque input is decoupled from the third torque input;
in a third mode of operation, the first clutch member is in the disengaged position such that the first torque input is decoupled from the second torque input and the second clutch member is in the engaged position such that the second torque input is coupled to the third torque input; and
in a fourth mode of operation, the first clutch member and the second clutch member are both in the engaged position such that the first torque input is coupled to the second torque input and the second torque input is coupled to the third torque input.

9. The clutch assembly of claim 8, wherein:
the first torque input includes surface features formed on an inner diameter;
the second torque input includes surface features formed on an outer diameter; and
the first clutch member includes surface features formed on inner and outer diameters thereof, wherein, in response to the first clutch member being in the engaged position:
the surface features on the outer diameter of the first clutch member matingly engage with the surface features on the inner diameter of the first torque input; and
the surface features on the inner diameter of the first clutch member matingly engage with the surface features on the outer diameter of the second torque input.

10. The clutch assembly of claim 9, wherein the surface features formed on the first torque input, the second torque input, and the first clutch member are splines.

11. The clutch assembly of claim 8, wherein:
the second torque input includes surface features formed on an inner diameter;
the third torque input includes surface features formed on an outer diameter; and
the second clutch member includes surface features formed on inner and outer diameters thereof, wherein, in response to the second clutch member being in the engaged position:
the surface features formed on the outer diameter of the second clutch member matingly engage with the surface features on the inner diameter of the second torque input; and
the surface features formed on the inner diameter of the second clutch member matingly engage with the surface features formed on the outer diameter of the third torque input.

12. The clutch assembly of claim 11, wherein the surface features formed on the second torque input, the third torque input, and the second clutch member are splines.

13. The clutch assembly of claim 8, wherein:
the first clutch member is disposed radially within the first torque input;
the second torque input is disposed radially within the first clutch member;
the second clutch member is disposed radially within the second torque input; and
the third torque input is disposed radially within the second clutch member.

14. A method of operating a clutch assembly having a first clutch member and a second clutch member, the method comprising:
moving the first clutch member between a first position where a first torque input is coupled to a second torque input to transmit torque therebetween and a second position where the first torque input is decoupled from the second torque input such that there is no torque transmission therebetween; and
moving the second clutch member between a first position where the second torque input is coupled to a third torque input to transmit torque therebetween and a second position where the second torque input is decoupled from the third torque input such that there is no torque transmission therebetween,
wherein the first clutch member is disposed radially between the first torque input and the second torque input, and the second clutch member is disposed radially inward of the first clutch member and radially between the second torque input and the third torque input.

15. The method of claim 14, further comprising, in a first mode of operation:
moving the first clutch member to the second position wherein the first torque input is decoupled from the second torque input; and
moving the second clutch member to the second position wherein the second torque input is decoupled from the third torque input.

16. The method of claim 15, further comprising, in a second mode of operation:
moving the first clutch member to the first position wherein the first torque input is coupled to the second torque input; and
moving the second clutch member to the second position wherein the second torque input is decoupled from the third torque input.

17. The method of claim 16, further comprising, in a third mode of operation:
moving the first clutch member to the second position wherein the first torque input is decoupled from the second torque input; and
moving the second clutch member to the first position wherein the second torque input is coupled to the third torque input.

18. The method of claim 17, further comprising, in a fourth mode of operation:
moving the first clutch member to the first position wherein the first torque input is coupled to the second torque input; and
moving the second clutch member to the first position wherein the second torque input is coupled to the third torque input.
